(19) United States
(12) Patent Application Publication
(10) Pub. No.: US 2013/0009883 A1
(43) Pub. Date: Jan. 10, 2013

(54) DISPLAY DEVICE

(75) Inventor: Wen-Zheng Chen, New Taipei City (TW)

(73) Assignee: CHUNGHWA PICTURE TUBES, LTD., Taoyuan (TW)

(21) Appl. No.: 13/213,087

(22) Filed: Aug. 19, 2011

(30) Foreign Application Priority Data
Jul. 4, 2011 (TW) 100123512

(51) Int. Cl. G06F 3/041

(52) U.S. Cl. 345/173

(57) ABSTRACT

A display device includes a display unit, a touch unit, a backlight unit and an electrophoresis unit. The touch unit is disposed over the display unit, the backlight unit is disposed under the display unit and the electrophoresis unit is disposed on the display unit, in which the electrophoresis unit includes a substrate, multiple display electrodes, at least one storage electrode, a gate electrode and multiple charged particles. The substrate has an active region and a peripheral region connecting the active region, the display electrodes are disposed at the active region of the substrate and arranged in a same interval, the storage electrode is disposed at the peripheral region of the substrate, the gate electrode is disposed at the peripheral region of the substrate and located between the display electrodes and the storage electrode, and the charged particles are disposed on the substrate have with mirror reflective property.

### CROSS-REFERENCE TO RELATED APPLICATION

This application claims the priority benefit of Taiwan application serial no. 100123512, filed on Jul. 4, 2011. The entirety of the above-mentioned patent application is hereby incorporated by reference herein and made a part of this specification.

### BACKGROUND OF THE INVENTION

1. Field of the Invention

The invention generally relates to a display device, and more particularly, to a display device with mirror reflective function.

2. Description of Related Art

Along with the progressing science and technology, all digital tools such as mobile phone, digital camera, digital video camera, notebook and desktop computer are developed towards more handiness, multiple functions and nice look. In these information products, a display panel is an inevitable man-machine interface, and a user has more convenient manipulation on the products through the display function of the display panel.

In terms of practicality, if a display panel has an additional mirror reflective effect, the application field thereof is certainly expanded. Recently, U.S. Pat. No. 7,636,195 provides a design that in a display, a mirror with polarized effect (i.e., polarized lens) is employed, so that the display can provide both displaying and mirroring functions. However, the area ratio between display region and mirror region in the design is fixed, so that a user is unable to adjust the area ratio between display region and mirror region according to the requirement thereof. In addition, since the light emitted from a backlight module needs to pass through an additional polarized lens, the integrated display quality of the display is reduced. In this regard, how to make a display have a mirror reflective function and meanwhile keep the good display quality is an important project in the current display field.

### SUMMARY OF THE INVENTION

Accordingly, the invention is directed to a display device having a mirror reflective function and meanwhile keeping the good display quality.

The invention provides a display device, which includes a display unit, a touch unit, a backlight unit and an electrophoresis unit. The touch unit is disposed over the display unit, the backlight unit is disposed under the display unit and the electrophoresis unit is disposed on the display unit, in which the electrophoresis unit includes a substrate, a plurality of display electrodes, at least one storage electrode, a gate electrode and a plurality of charged particles. The substrate has an active region and a peripheral region connecting the active region, the display electrodes are disposed at the active region of the substrate and arranged in a same interval, the storage electrode is disposed at the peripheral region of the substrate, the gate electrode is disposed at the peripheral region of the substrate and located between the display electrodes and the storage electrode, and the charged particles are disposed on the substrate and have mirror reflective property.

In an embodiment of the present invention, the above-mentioned display electrodes, storage electrode and gate electrode are the same layer.

In an embodiment of the present invention, the materials of the above-mentioned display electrodes, storage electrode and gate electrode are transparent conductive material.

In an embodiment of the present invention, each of the above-mentioned charged particles includes a spherical spacer, a metal layer and a charged polymer. The metal layer encapsulates the spherical spacer and the charged polymer encapsulates the metal layer.

In an embodiment of the present invention, each of the above-mentioned charged particles includes a nano metal particle and a function base. The diameter of the nano metal particle is less than 100 nm and the function base is joined with the surface of the nano metal particle.

In an embodiment of the present invention, when the above-mentioned charged particles are distributed at the active region of the substrate and entirely located over the display electrodes, the display device is in a complete mirror reflective status.

In an embodiment of the present invention, when the above-mentioned charged particles are distributed at the active region of the substrate and located over the partial display electrodes, the display device is in a local display plus local mirror reflective status.

In an embodiment of the present invention, when the above-mentioned charged particles are distributed at the peripheral region of the substrate and entirely located over the storage electrode, the display device is in a complete display status.

In an embodiment of the present invention, the above-mentioned display device further includes an upper polarizer and a lower polarizer. The upper polarizer is disposed on the display unit and located between the touch unit and the display unit. The lower polarizer is disposed on the electrophoresis unit and located between the electrophoresis unit and the backlight unit.

In an embodiment of the present invention, the above-mentioned electrophoresis unit is disposed between the display unit and the backlight unit.

In an embodiment of the present invention, the above-mentioned electrophoresis unit is disposed between the touch unit and the display unit.

In an embodiment of the present invention, the above-mention electrophoresis unit further includes an opposite substrate disposed over the substrate and adjacent to the touch unit.

In an embodiment of the present invention, the above-mentioned electrophoresis unit further includes an opposite substrate disposed under the substrate and adjacent to the backlight unit.

Based on the depiction above, since the electrophoresis unit of the invention has a plurality of charged particles therein and the charged particles have mirror reflective property, so that a user can adjust a voltage difference to change the distribution of the charged particles according to the application need and the display device is accordingly in a complete mirror reflective status, a local display plus local minor reflective status or a complete display status. In this way, the display device of the invention can have mirror reflective function and keep the original display quality. In addition, since the electrophoresis unit of the invention has a plurality of display electrodes, which can easily control the variation of the electrical field and avoid the problems of uneven distribution and slow migrating of the charged particles.

Other objectives, features and advantages of the present invention will be further understood from the further technological features disclosed by the embodiments of the present invention in which there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional diagram of a display device according to an embodiment of the invention.

FIG. 1B is an enlarged schematic diagram of a charged particle in FIG. 1A according to an embodiment of the invention.

FIG. 1C is an enlarged schematic diagram of a charged particle in FIG. 1A according to another embodiment of the invention.

FIG. 2 is a schematic diagram of the display device of FIG. 1A in complete display status.

FIG. 3 is a schematic diagram of the display device of FIG. 1A in complete mirror reflective status.

FIG. 4 is a schematic diagram of the display device of FIG. 1A in local display plus local mirror reflective status.

FIG. 5 is a cross-sectional diagram of a display device according to another embodiment of the invention.

FIG. 6 is a cross-sectional diagram of a display device according to yet another embodiment of the invention.

FIG. 7 is a schematic diagram showing a driving course of the electrophoresis unit in the display device of FIG. 1A converted to the complete display status from the complete mirror reflective status.

FIG. 8 is a schematic diagram showing a driving course of the electrophoresis unit in the display device of FIG. 1A converted to the complete mirror reflective status from the complete display status.

### DESCRIPTION OF THE EMBODIMENTS

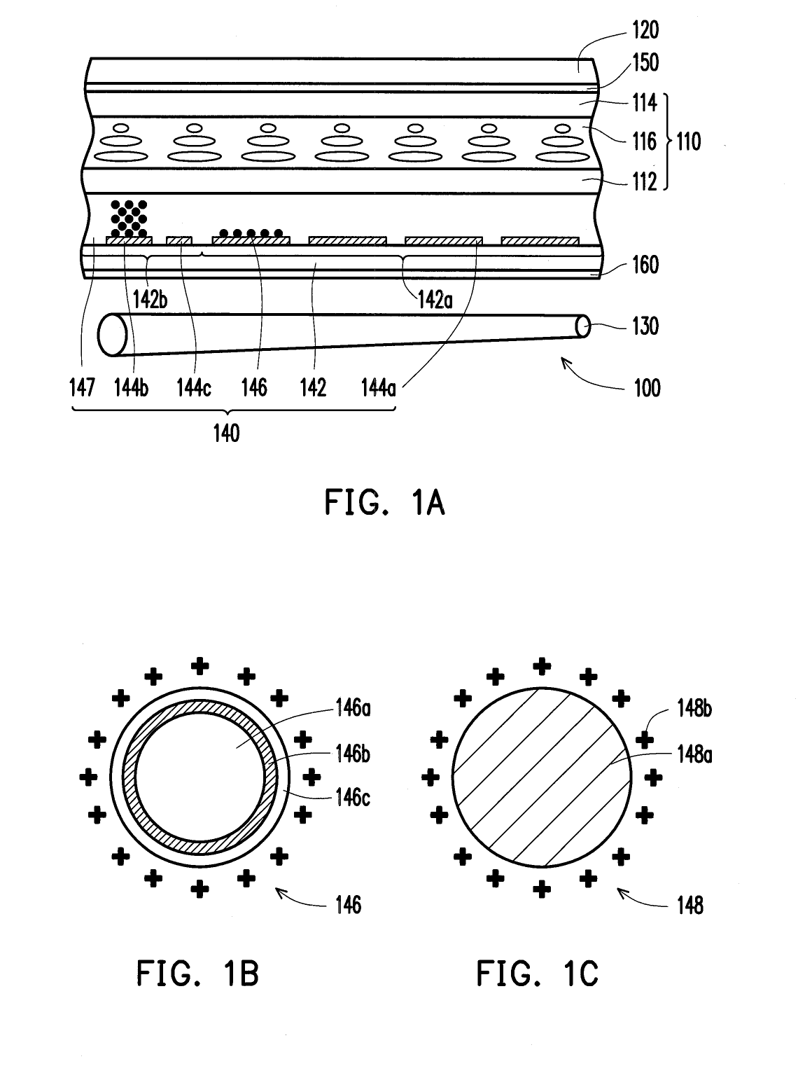

FIG. 1A is a cross-sectional diagram of a display device according to an embodiment of the invention. FIG. 1B is an enlarged schematic diagram of a charged particle in FIG. 1A according to an embodiment of the invention. FIG. 1C is an enlarged schematic diagram of a charged particle in FIG. 1A according to another embodiment of the invention. Referring to FIG. 1A at first, in the embodiment, a display device 100 includes a display unit 110, a touch unit 120, a backlight unit 130 and an electrophoresis unit 140. The touch unit 120 is disposed over the display unit 110, the backlight unit 130 is disposed under the display unit 110 and the electrophoresis unit 140 is disposed between the display unit 110 and the backlight unit 130.

In more details, the touch unit 120 is, for example, a resistive touch panel, a capacitive touch panel, an optical touch panel, an acoustic touch panel or an electromagnetic touch panel, which the invention is not limited to. The display unit 110 includes a first substrate 112, a second substrate 114 and a liquid crystal layer 116 between the first substrate 112 and the second substrate 114. For example, in the embodiment, the display unit 110 is a liquid crystal display panel (LCD panel), in which the first substrate 112 is, for example, an active device array substrate and the second substrate 114 is, for example, a color filter substrate. It should be noted that the invention does not limit the type of the LCD panel, which can be, for example, multi-domain vertical alignment (MVA) LCD panel, twisted nematic (TN) LCD panel or fringe field switching (FFS) LCD panel, but the selected LCD panel must be in normally white mode. In addition, the backlight unit 130 is, for example, a direct-type light source module or a side-type light source module.

The electrophoresis unit 140 is disposed between the display unit 110 and the backlight unit 130, in which the electrophoresis unit 140 includes a substrate 142, a plurality of display electrodes 144a (only four ones are shown in FIG. 1A), at least one storage electrode 144b (only one is shown in FIG. 1A), a gate electrode 144c, a plurality charged particles 146 of and a transparent fluid 147. In more details, the substrate 142 has an active region 142a and a peripheral region 142b connected to the active region 142a. The display electrodes 144a are disposed at the active region 142a of the substrate 142 and arranged in a same interval. The storage electrode 144b is disposed at the peripheral region 142b of the substrate 142. The gate electrode 144c is disposed at the peripheral region 142b of the substrate 142 and located between the display electrodes 144a and the storage electrode 144b. The display electrodes 144a, the storage electrode 144b and the gate electrode 144c herein belong to a same layer, and the materials of the display electrodes 144a, the storage electrode 144b and the gate electrode 144c are transparent conductive material. The charged particles 146 are disposed on the substrate 142 and have mirror reflective property. The transparent fluid 147 is disposed between the substrate 142 and the first substrate 112 and covers the substrate 142, the display electrodes 144a, the storage electrode 144b, the gate electrode 144c and the charged particles 146.

In more details, referring to FIG. 1B, each of the charged particles 146 includes a spherical spacer 146a, a metal layer 146b and a charged polymer 146c, in which the metal layer 146b encapsulates the surface of the spherical spacer 146a so that the spherical spacer 146a has mirror reflective effect, while the charged polymer 146c encapsulates the metal layer 146b so that the spherical spacer 146a has electricity. In the embodiment, the metal layer 146b is, for example, a silver layer and the charged polymer 146c is, for example, a positive-charged polymer or a negative-charged polymer.

Referring to FIG. 1A again, in the embodiment, the display device 100 further includes an upper polarizer 150 and a lower polarizer 160. The upper polarizer 150 is disposed on the display unit 110 and located between the touch unit 120 and the display unit 110. The lower polarizer 160 is disposed on the electrophoresis unit 140 and located between the electrophoresis unit 140 and the backlight unit 130.

It should be noted that the invention does not limit the type of the charged particles 146, although the above-mentioned charged particle 146 is composed of a spherical spacer 146a, a metal layer 146b and a charged polymer 146c; however in other embodiments, referring to FIG. 1C, each of the charged particles 148 can be composed of a nano metal particle 148a and a plurality of function bases 148b, in which the nano metal particle 148a has mirror reflective effect and the diameter of the nano metal particle 148a is less than 100 nm. The function bases 148b are joined with the surface of the nano metal particle 148a, so that the nano metal particle 148a has electricity. The charged particles 146 in FIG. 1B are an exemplary example, which the invention is not limited to. The charged particles 146 are, as an example, depicted in follows.

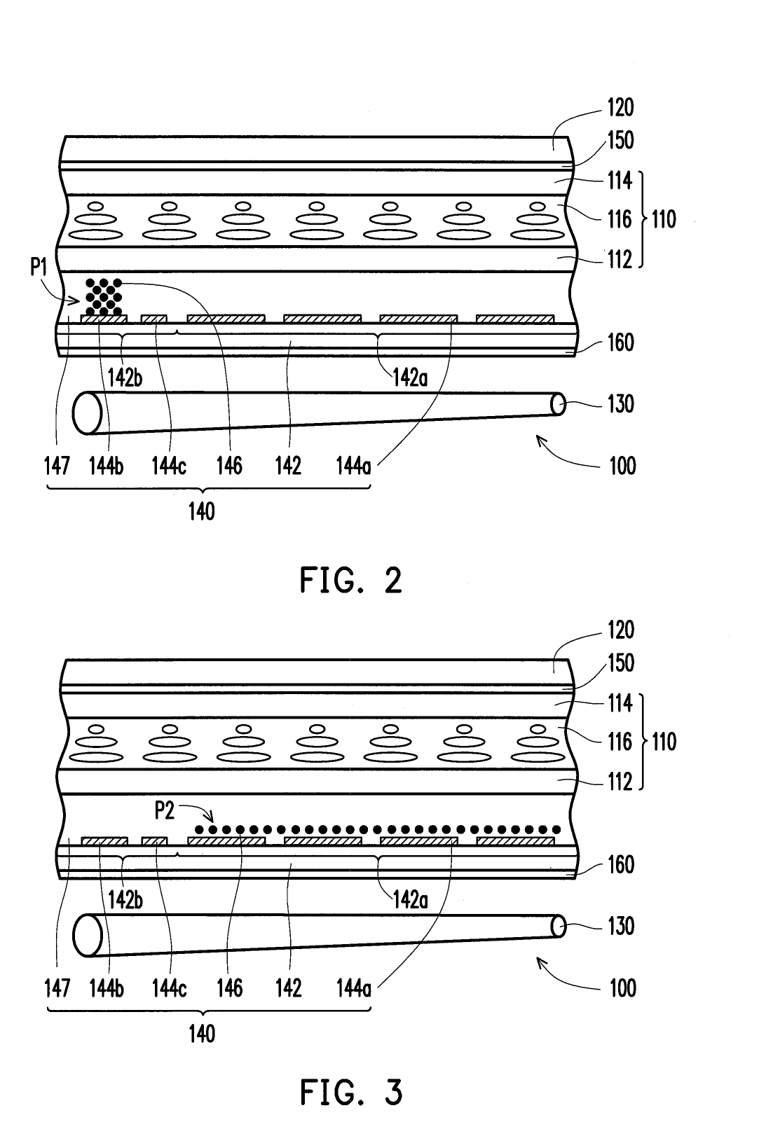

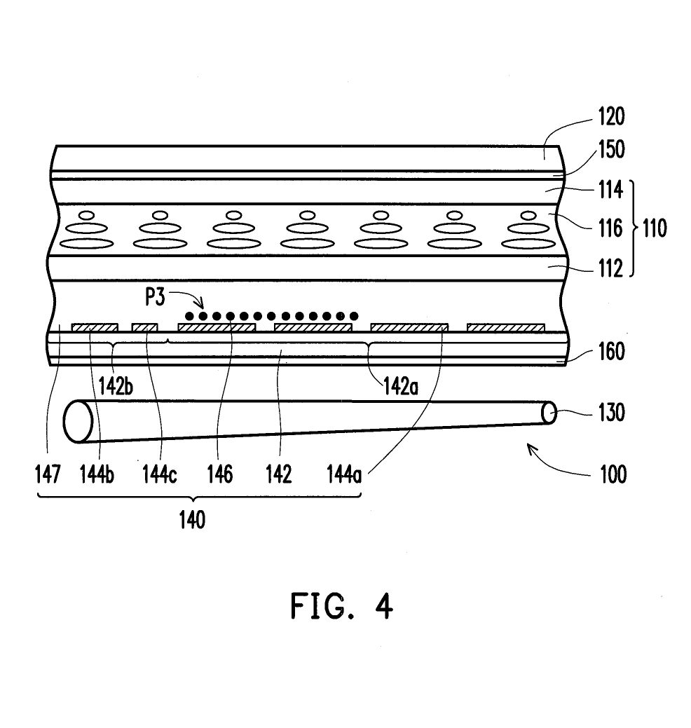

The status the display device 100 has is described when the charged particles 146 are distributed at different regions of the substrate 142 of the electrophoresis unit 140 (for example, at the active region 142a and the peripheral region 142b). FIG. 2 is a schematic diagram of the display device of FIG. 1A in complete display status. FIG. 3 is a schematic diagram of the display device of FIG. 1A in complete mirror reflective status. FIG. 4 is a schematic diagram of the display device of FIG. 1A in local display plus local mirror reflective status. In short, the touch unit 120 in the embodiment sends a signal to control electrical field so as to produce a voltage difference to adjust the distribution of the charged particles 146, and the display device 100 accordingly has a complete display status, a local display plus local mirror reflective status and a complete mirror reflective status.

In more details, referring to FIG. 2, when all the charged particles 146 due to a voltage difference gather at the peripheral region 142b of the substrate 142 and entirely located over the storage electrode 144b, the display device 100 has a complete display status. Referring to FIG. 3, when the charged particles 146 migrate to the active region 142a of the substrate 142 due to a voltage difference and are entirely located over the display electrodes 144a, the display device 100 has a complete mirror reflective status. Referring to FIG. 4, when the charged particles 146 migrate to the active region 142a of the substrate 142 due to a voltage difference and located on the partial display electrodes 144a, the region with the charged particles 146 has a mirror reflective status, while the region without the charged particles 146 has a display status. That is to say, the display device 100 at the time has a local display plus local mirror reflective status.

Since the electrophoresis unit 140 of the embodiment has the charged particles 146 therein and the charged particles 146 has mirror reflective property, so that when the touch unit 120 in the embodiment sends a signal to control electrical field, a voltage difference is produced to drive the charged particles 146 for migration, and, as a result, the distribution of the charged particles 146 makes the display device 100 have the complete display status, the local display plus local mirror reflective status and the complete mirror reflective status. The user can adjust the ratio between the display region (the region without the charged particles 146) and the mirror reflective region (the region with the charged particles 146) to meet the application requirement according to the above-mentioned mechanism. In comparison with the prior art, the display device 100 of the embodiment enables the user to adjust the area ratio between the display region and the mirror reflective region according to need. In this way, the application scope of the display device 100 is effectively expanded.

In the embodiment, the complete display status, the local display plus local mirror reflective status and the complete mirror reflective status are achieved by means of different distributions of the charged particles 146. In comparison with the prior art where a polarized lens is employed, the display device 100 of the embodiment can have mirror reflective function meanwhile keeping the original display quality. In addition, since there are the display electrodes 144a in the electrophoresis unit 140 of the invention, the electrical field is easily changed by control, which can avoid the problems of uneven distribution and slow migrating of the charged particles 146.

Two more different embodiments are given in follows, which include two display devices 100a and 100b. It should be noted that, the notations and partial content in the above-mentioned embodiment are continuously used, in which the same notations represent the same as or similar to the above-mentioned embodiment, while the same depictions are omitted and can be understood referring to the above-mentioned embodiment.

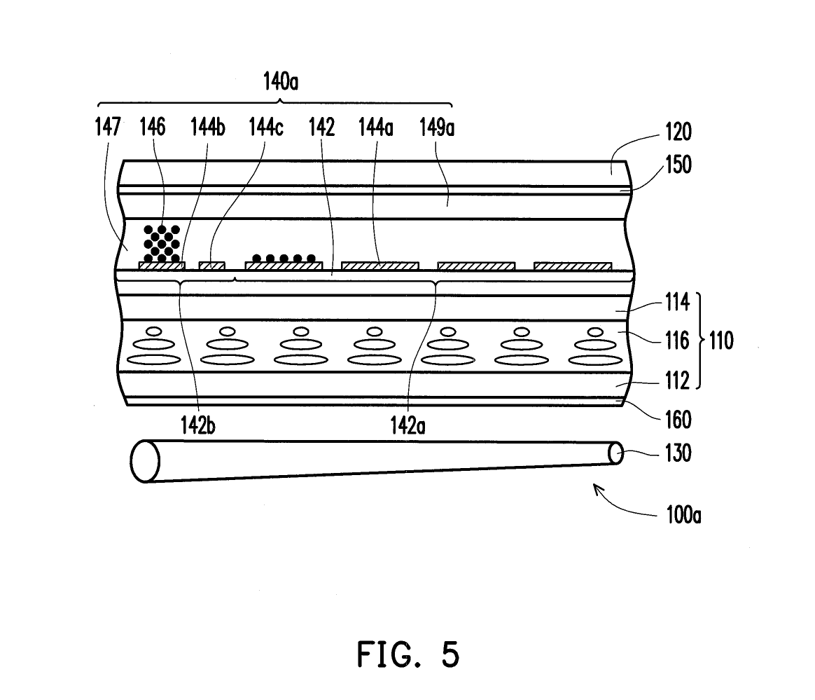

FIG. 5 is a cross-sectional diagram of a display device according to another embodiment of the invention. Referring to FIG. 5, the display device 100a of the embodiment is similar to the display device 100 of FIG. 1A except that the electrophoresis unit 140a of the display device 100a is disposed between the touch unit 120 and the display unit 110, and the electrophoresis unit 140a further includes an opposite substrate 149a, in which the opposite substrate 149a is disposed over the substrate 142 and adjacent to the touch unit 120.

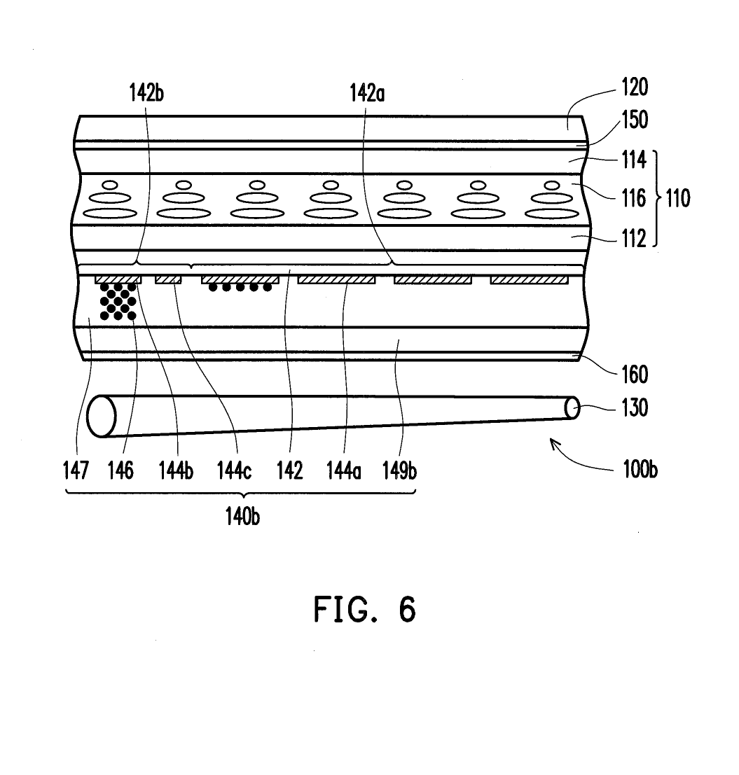

FIG. 6 is a cross-sectional diagram of a display device according to yet another embodiment of the invention. Referring to FIG. 6, the display device 100b of the embodiment is similar to the display device 100 of FIG. 1A except that the electrophoresis unit 140b of the display device 100b further includes an opposite substrate 149b, in which the opposite substrate 149b is disposed under the substrate 142 and adjacent to the backlight unit 130. In other embodiments, since the electrophoresis unit 140b is located between the display unit 110 and the backlight unit 130 and disposed on the display unit 110, the electrophoresis unit 140b and the display unit 110 can share one substrate, which means the display electrodes 144a, the storage electrode 144b and the gate electrode 144c of the electrophoresis unit 140b can be fabricated on the first substrate 112 of the display unit 110 so as to reduce the fabrication cost of the display device 100b.

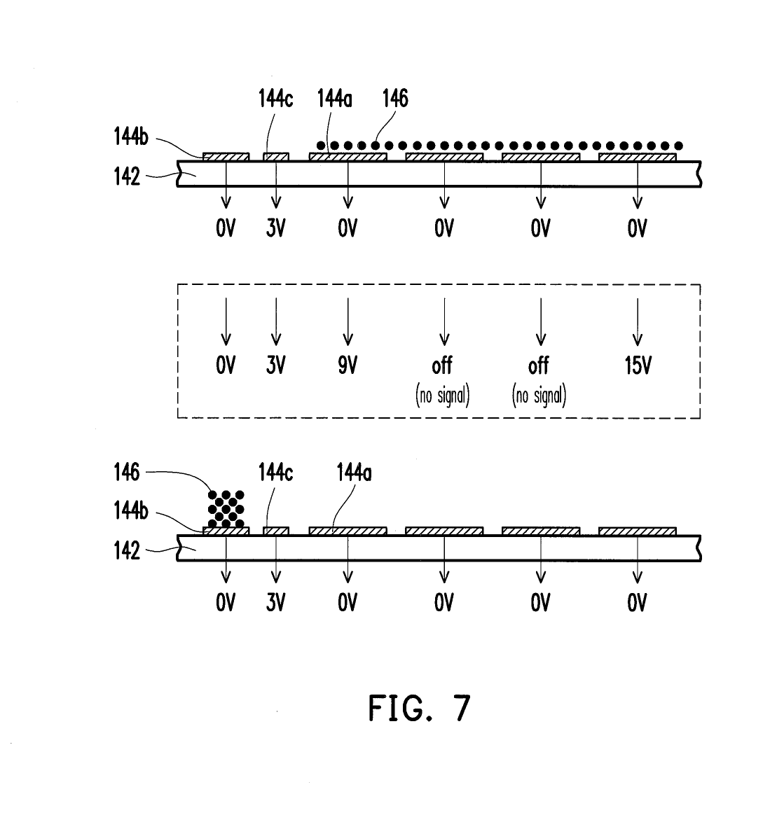

FIG. 7 is a schematic diagram showing a driving course of the electrophoresis unit in the display device of FIG. 1A converted to the complete display status from the complete mirror reflective status. Referring to FIG. 7, the initial voltages of the storage electrode 144b and the display electrodes 144a are 0V and the voltage of the gate electrode 144c is 3V, and the charged particles 146 are kept on the display electrodes 144a. The display device 100 at the time is in a complete mirror reflective status. Then, the voltages of the storage electrode 144b and the gate electrode 144c are respectively 0V and 3V; and 9V, no signal, no signal and 15V are respectively provided to the four display electrodes 144a. At the time, the voltage difference between the display electrode 144a most far away from the gate electrode 144c and the gate electrode 144c forms an electrical field, and the voltage difference between the gate electrode 144c and the storage electrode 144b forms another electrical field, and the electrical fields in the embodiment are used to migrate the charged particles 146 onto the storage electrode 144b, so that the display device 100 is converted into a complete display status from the complete mirror reflective status, referring to FIG. 2.

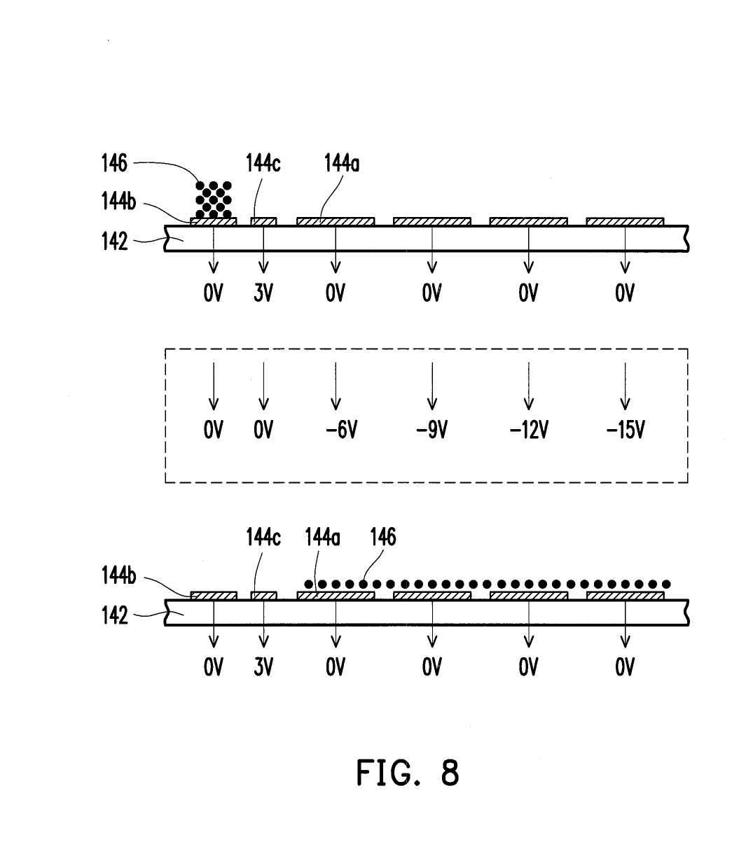

FIG. 8 is a schematic diagram showing a driving course of the electrophoresis unit in the display device of FIG. 1A converted to the complete mirror reflective status from the complete display status. Referring to FIG. 8, the initial voltages of the storage electrode 144b and the display electrodes 144a are 0V, the voltage of the gate electrode 144c is 3V, and the charged particles 146 are kept on the storage electrode 144b. At the time, the display device 100 is in a complete display status. Then, the voltages of the storage electrode 144b and the gate electrode 144c are 0V; and four voltages of −6V, −9V, −12V and −15V are respectively provided to the four display electrodes 144a, in which the display electrode 144a closer to the gate electrode 144c has a higher voltage and the display electrode 144a farther away from the gate electrode 144c has a lower voltage. The voltage difference between the storage electrode 144b and the display electrodes 144a forms an electrical field, and the electrical field makes the charged particles 146 are driven by the field and migrate onto the display electrodes 144a. Further, the embodiment can use the electrical field formed by the voltage difference between two adjacent display electrodes 144a to assist in evenly distributing the charged particles 146 on the four display electrodes 144a. After that, the voltage of the gate electrode 144c is changed to 3V, and the voltages of the rest display electrodes 144a and storage electrode 144b are changed to 0V, so that the charged particles 146 can be kept on the display electrodes 144a. At the time, the display device 100 has been converted into a complete mirror reflective status from the complete display status, referring to FIG. 3.

In summary, since the electrophoresis unit of the invention has a plurality of charged particles therein and the charged particles have mirror reflective property, so that a user can adjust a voltage difference to change the distribution of the charged particles according to the application need and the display device is accordingly in a complete mirror reflective status, a local display plus local mirror reflective status or a complete display status. In this way, the display device of the invention can have mirror reflective function and keep the original display quality. In addition, since the electrophoresis unit of the invention has a plurality of display electrodes, which can easily control the variation of the electrical field and avoid the problems of uneven distribution and slow migrating of the charged particles.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive.

What is claimed is:

1. A display device, comprising:
a display unit;
a touch unit, disposed over the display unit;
a backlight unit, disposed under the display unit; and
an electrophoresis unit, disposed on the display unit, wherein the electrophoresis unit comprises:
a substrate, having an active region and a peripheral region connecting the active region;
a plurality of display electrodes, disposed at the active region of the substrate and arranged in a same interval;
at least one storage electrode, disposed at the peripheral region of the substrate;
a gate electrode, disposed at the peripheral region of the substrate and located between the display electrodes and the storage electrode; and
a plurality of charged particles, disposed on the substrate and having mirror reflective property.

2. The display device as claimed in claim 1, wherein the display electrodes, the storage electrode and the gate electrode are the same layer.

3. The display device as claimed in claim 1, wherein materials of the display electrodes, the storage electrode and the gate electrode are transparent conductive material.

4. The display device as claimed in claim 1, wherein each of the charged particles comprises:
a spherical spacer;
a metal layer, encapsulating the spherical spacer; and
a charged polymer, encapsulating the metal layer.

5. The display device as claimed in claim 1, wherein each of the charged particles comprises:
a nano metal particle, wherein the diameter of the nano metal particle is less than 100 nm; and
a function base, joined with the surface of the nano metal particle.

6. The display device as claimed in claim 1, wherein when the charged particles are distributed at the active region of the substrate and entirely located over the display electrodes, the display device is in a complete mirror reflective status.

7. The display device as claimed in claim 1, wherein when the charged particles are distributed at the active region of the substrate and located over the partial display electrodes, the display device is in a local display plus local mirror reflective status.

8. The display device as claimed in claim 1, wherein when the charged particles are distributed at the peripheral region of the substrate and entirely located over the storage electrode, the display device is in a complete display status.

9. The display device as claimed in claim 1, further comprising:
an upper polarizer, disposed on the display unit and located between the touch unit and the display unit; and
a lower polarizer, disposed on the electrophoresis unit and located between the electrophoresis unit and the backlight unit.

10. The display device as claimed in claim 1, wherein the electrophoresis unit is disposed between the display unit and the backlight unit.

11. The display device as claimed in claim 1, wherein the electrophoresis unit is disposed between the touch unit and the display unit.

12. The display device as claimed in claim 11, wherein the electrophoresis unit further comprises an opposite substrate, disposed over the substrate and adjacent to the touch unit.

13. The display device as claimed in claim 1, wherein the electrophoresis unit further comprises an opposite substrate, disposed under the substrate and adjacent to the backlight unit.
